(19) United States
(12) Patent Application Publication
(10) Pub. No.: US 2002/0146276 A1
(43) Pub. Date: Oct. 10, 2002

(54) Disconnectable joint

(75) Inventor: Hermann Le Guin, Amtzell (DE)

Correspondence Address: OLIFF & BERRIDGE, PLC, P.O. BOX 19928, ALEXANDRIA, VA, 22320, US

(73) Assignee: RENISHAW PLC, Gloucestershire (GB)

(21) Appl. No.: 10/101,224

(22) Filed: Mar. 20, 2002

(30) Foreign Application Priority Data
Mar. 20, 2001 (GB) 0106870.9

(51) Int. Cl. F16D 1/00

(52) U.S. Cl. 403/14

(57) ABSTRACT

A coordinate measurement machine 10 has a movable head 20. A probe 12 and arm 14 are attached via a disconnectable joint to the head. An exchange rack 30 is provided for exchanging one probe/arm, for another. A plate 50 acts to disconnect and reconnect the joint and also to support the probe/arm whilst disconnected. Plate 50 actuates a toggle mechanism 42 when the head is moved relative to the plate and causes a plunger 26 to engage/disengage with a peg 24 thereby securing or releasing the joint during the said movement.

### BACKGROUND OF THE INVENTION

1. Field of the Invention

The present invention relates to a disconnectable joint particularly but not necessarily for use with measurement components having two joinable elements.

2. Description of the Prior Art

There are many ways of providing a disconnectable joint, i.e. one which can be repeatedly made and unmade. For measurement components at least, it is often desirable to repeatedly make and break a joint but to have the components returned to the same relative position every time the joint is remade. The need for automatic connection and disconnection of parts is also desirable. As a result of these requirements some known joints are complicated and unreliable.

Examples of joints are disclosed in EuropeAn Patent No. 0142373 and United Kingdom Patent No. 1,599,751.

### SUMMARY OF THE INVENTION

The present invention, according to a first aspect, provides a disconnectable joint comprising first and second connectable parts, a peg resiliently mounted to the first part and a pin slidably mounted to the second part and engageable with the peg when the first and second parts are connected wherein the peg has an enlarged end and the pin is slidably engageable with the enlarged end to keep the parts connected. The pin may be urged into engagement with the peg by a spring force.

Preferably the pin is slidable in use by means of a toggle mechanism. More preferably there is a toggle mechanism on each side of the pin.

Preferably the joint includes an actuation plate having a cam profile, the plate being adapted for causing the toggle mechanism to move during relative displacement of the plate and the toggle mechanism thereby to disconnect the two parts.

Preferably the plate is adapted to support the second part when the second part is disconnected from the first part.

The invention provides also, according to a second aspect, a coordinate measurement machine having a measurement device connected to a mounting head by a joint according to the first aspect, or its preferred features.

Preferably an actuation plate adapted for disconnecting the joint, provides support for the probe when disconnected from the mounting head.

### BRIEF DESCRIPTION OF THE DRAWINGS

The invention will now be described with reference to the drawings, wherein:

FIG. 1 shows an embodiment of the invention used on measuring equipment;

FIG. 2 shows a cut-away view of the joint shown in FIG. 1;

FIG. 3 shows a partially cut-away component of the joint shown in FIG. 2;

FIG. 4 shows another view of components of the joint shown in FIG. 2;

FIGS. 5a,5b and 5c are a schematic representation of the toggle mechanism used in the joint shown in FIG. 2; and

FIG. 6 is an alternative embodiment of the invention.

### DESCRIPTION OF THE PREFERRED EMBODIMENTS

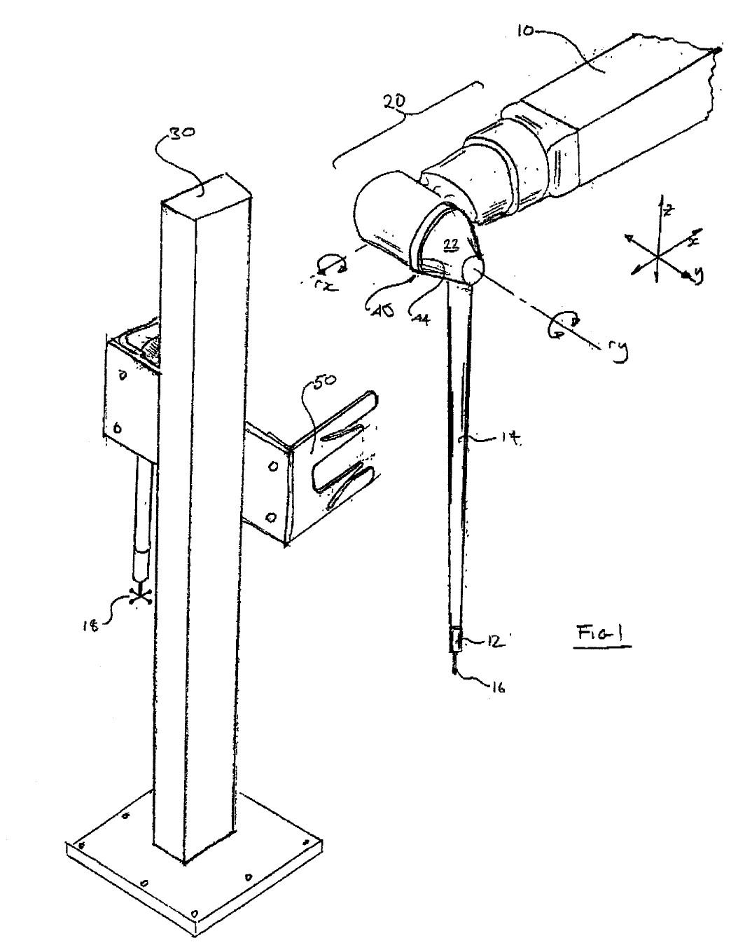

Referring to FIG. 1 there is shown an quill 10 of a coordinate measurement machine (CMM) having a movable measurement head 20 mounted thereto. Attached to the head is a measurement device in the form of a probe 12 and in this instance an extension arm 14 with a base 22, The probe has a stylus tip 16 used to obtain workpiece dimensional information. The arbor is capable of translational movement in x,y and z directions and the head 20 can cause the stylus to move in rotation about axes rx and ry. Thus the probe 12 and stylus 16 can be moved in a multitude of directions. However, to increase the range of measurement that the CMM can carry out, different probes, styli and extensions can be used. An alternative stylus, in this case a star stylus 18 for bore measurement, is supported on a rack 30 and this alternative stylus together with its arm and base can be exchanged for the probe 12, stylus 16, arm 14 and base 22 shown attached to the head 20. Exchange of styli and extension arms takes place by removing the presently attached probe and extension ant and replacing it with another. This is carried out either manually or (preferably and in this example) automatically. Automatic exchange is carried out by moving the head 20 to the rack 30, Goading into the rack 30, a probe/arm 12/14 and then moving to another position to reload the head with another probe/arm.

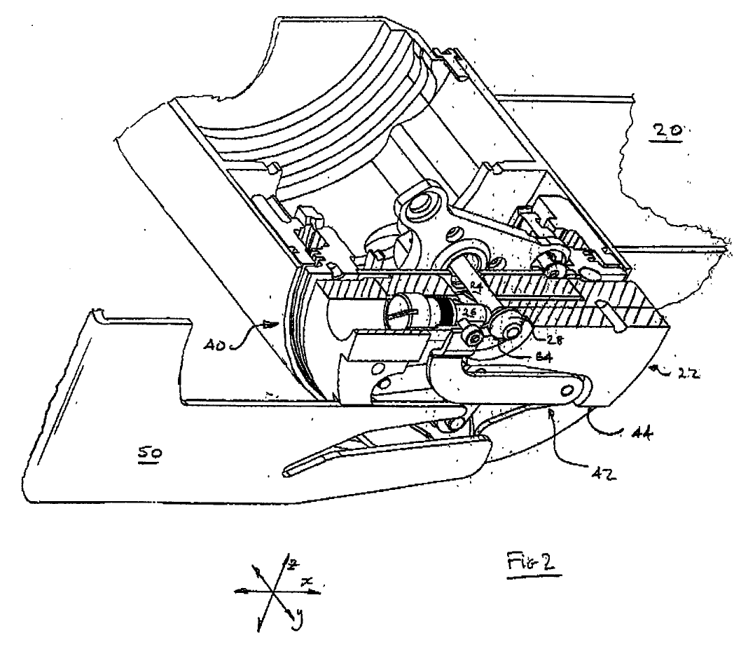

Automatic changing of the stylus is made possible by the provision of a disconnectable joint 40 at the base 22, one embodiment of which is shown in FIGS. 2-4 and described below.

The joint 40 makes use of an actuator plate 50 held on the rack 30. In use the joint 40 is moved to the plate 50 and the plate is caused to be driven into the joint, resulting in disconnection of the joint and separation of the head 20 from the base 22. The plate subsequently provides support for the dieconnected probe/arm.

The head, without the probe/arm attached, is then moved to a new position adjacent the alternative probe/arm. The head is moved away from the new position, pulling with it the alternative base with its probe/arm. When the head has moved sufficiently far and an actuation plate is withdrawn from the joint 40 then the disconnectable joint 40 between the head 20 and the alternative base is remade.

FIG. 2 shows the joint 40 and a plate 50 in more detail. A portion only of head 20 is shown as a cut-away view. A portion only of base 22 is shown. For, clarity the portion of the base shown has been hatched, whereas the portion of the head shown has not been hatched. The view is substantially a half-section and is substantially mirrored by the parts not shown.

In this embodiment the head 20 forms a first part of the joint and the base 22 forms a second part. The head has a resiliently mounted peg 24, an: enlarged end 28 of which is capturable by a slidable pin or plunger 26 of the base.

Plunger 26 is movable away from the peg by means of a toggle mechanism 42, described in detail below. The toggle mechanism 42 is actuated by plate 50 as it moves into a slot 44 formed in the base 22. When the plate 50 is in the slot the joint can be disconnected by withdrawal of the peg 24 from the base 22, principally in the y direction.

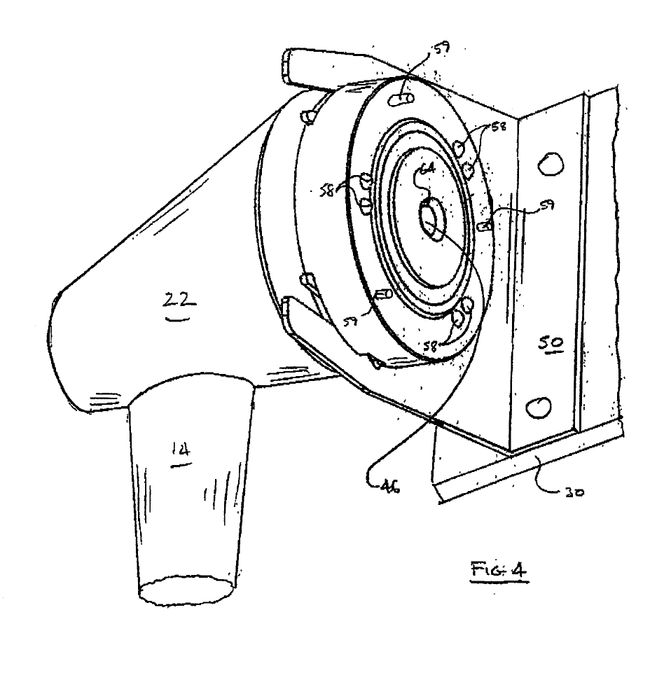

Removal of the plate 50 either with or, without the base 22 being connected to the head 20, actuates the toggle mechanism 42 and forces plunger 26 to slide toward and engage peg 24 or, if no peg is present then in the direction of an access hole (46 FIG. 4.) in which the peg would sit.

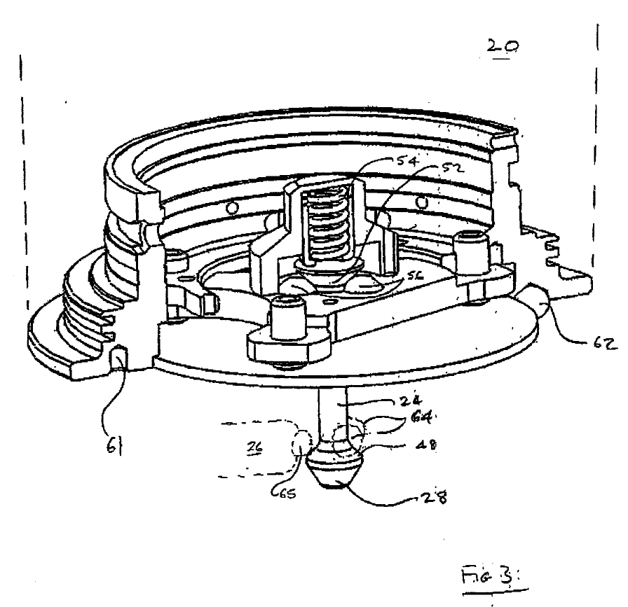

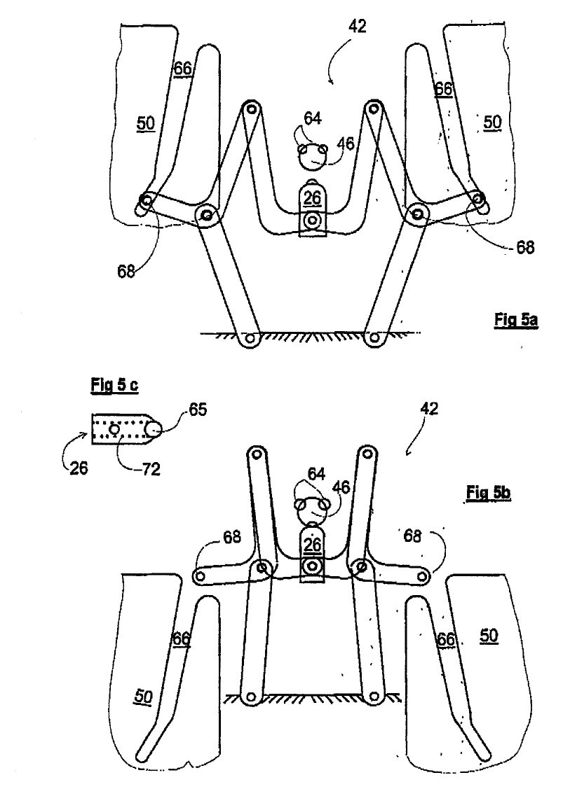

FIG. 3 shows the peg assembly in more detail. The peg 24 is mounted for resilient movement. A conical portion 52 is urged by coiled spring 54 against three static balls 56. In use the peg may be forced from its urged position in order to enter. or leave hole 46. Plunger 26 in the base 22 is pushed towards a face 48 of the enlarged end of the peg. A sprung, ball 65 is captively housed within the plunger 26 (as detailed in FIG. 5c). When the plunger is pushed by the toggle mechanism 42 toward the peg 24 then the ball 65 contacts the face 48 of the peg and is urged by a spring 72 inside the plunger so as to retain contact with the face 48. This action brings together and holds the head and the base.

FIG. 3 shows also the two peg location balls 64, again mounted in the base, which stop the plunger from pushing the peg 24 too far, and provide together with ball 65, three points of contact on the face 48 of the peg. Plunger 26 and the two balls 64 are illustrated in their operative position in FIG. 3. When the plunger 4. 26 is moved away from the peg 24 by the, toggle mechanism, the peg, by virtue of its resilient mounting, is capable of sliding over the two balls 64 whilst head 20 is moved away from the now disconnected base 22.

FIG. 4 shows a base 22 and arm 14,supported by a plate 50. This view shows three pairs of balls 58 which in use each come together with one of three further balls 4 (62 FIG. 3, only one of which can be seen) fixed to head 20. These ball locations form a kinematic location which allows repeatable positioning of the joint parts each time the joint is broken and remade. To aid initial alignment of the base and head three pins 59 in the head are acceptable within three holes 61 in the base one of which only is shown in FIG. 3.

Rack 30 may be provided with a plurality of plates so o so that various bases can be supported thereon.

FIGS. 5a and 5b show two positions of the toggle mechanism 42 shown in FIG. 2. FIG. 5a is an unlocked position where the plunger 26 is withdrawn from access hole 46 and is the state in which plate So holds the toggle mechanism 42 when it supports a base 22. A lug 68 of the toggle mechanism FIG. 5b is captured and caused to move in a cam slot 66 in the plate. Relative displacement of the slot 66 and lug 68 causes actuation of the toggle mechanism 42. FIG. 5b shows a locked position at which ball 65 in plunger 26 is engaged with peg 24. In use this position will normally only be occasioned when the plate So is not engaged with the toggle mechanism 42, i.e. when the joint 40 is made and the head 20 and the base 22 are adjoined. Therefore peg 24 is omitted from the hole 46 for clarity. Lug 68 has been moved by the plate 50 into a position whereby the plunger 26 is in its operative position and is urging ball 65 into engagement with peg 24.

FIG. 5c shows a section through plunger 26. Captively held ball 65 is loaded by means of captive spring 72.

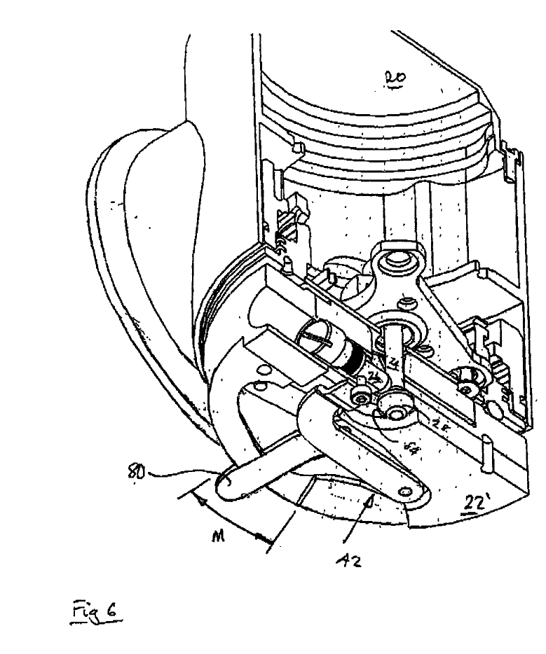

FIG. 6 shows an alternative embodiment of the invention. A half-section is shown in this Figure tibrough head 20 and part of base 22a. These parts are similar in construction to the head 20 and base 22 described above. However, a different toggle mechanism 42′ is shown in this embodiment. The toggle mechanism 42′ has levers to one side only of plunger 26 and 30 is not mirrored in the missing half of the head 20 and base 22′. Rather than an actuator plate, plunger 26 is caused to move by the manual operation of a lever so between the extremities of movement shown by arrow M. The position shown is the locked/connected position of the joint 40. Moving the lever will cause the plunger 26 to withdraw from hole 46 and the head and base can then be manually separated.

Many variants and modifications of the construction shown will be apparent to the skilled addressee. In particular the manner in which the plunger 26 may be moved, rather than by means of the toggle mechanism illustrated, could be by means of any displacement device, powered or manually operated e.g. a solenoid. Plate or plates 50 may be supported in any manner and in any orientation. Likewise the base(s) may be supported in any orientation on the plate(s), e.g. a plate may have its slots facing upwardly and the base may be supportable on such a plate with its arm 14 extending upwardly.

Moreover, whilst the invention is illustrated with reference to a joint between two parts of a measurement apparatus, the invention is not intended to be so restricted, and can find application in many other fields.

1. A disconnectable joint comprising first and second connectable parts, a peg resiliently mounted to the first part and a pin slidably mounted, to the second part and engageable with the peg when the first and second parts are connected wherein the peg has an enlarged end and the pin is slidably engageable with the enlarged and to keep the parts connected.

2. A disconnectable joint as claimed in claim 1 wherein the pin is urged into'engagement with a peg by a spring force.

3. A disconnectable joint as claimed in claim 1 wherein the joint includes a toggle mechanism and the pin is caused to slide in use by means of the toggle mechanism.

4. A disconnectable joint as claimed pin claim 3 wherein there is a toggle mechanism on each side of the pin.

5. A disconnectable joint as claimed in claim 3 wherein the joint includes an actuation plate having a cam profile, the plate being adapted for causing the toggle mechanism to move during relative displacement of the plate and the toggle mechanism thereby to disconnect the two parts.

6. A disconnectable joint as claimed in claim 5 wherein the plate is adapted to support on e of the parts when the other of the parts is disconnected.

7. A coordinate measurement machine comprising a mounting head, a measurement device and a disconnectable joint between the head and the device, and comprising an actuator, movement of the head and device together relative to the actuator causing connection or disconnection of the joint, the actuator providing support for the device when disconnected from the head.

8. A coordinate measurement machine as, claimed in claim 7 wherein the disconnectable joint comprises a peg resiliently mounted to either the head or the device, and a pin slidably mounted to the other of the head or the device, the pin being engageable with the peg when the head and device are connected.

9. A disconnectable joint comprising first and second connectable parts, a peg resiliently mounted to the first part and a pin slidably mounted to the second part and engageable with the peg when the first and second parts are connected wherein;
the peg has an enlarged end and the pin is slidably engageable with the enlarged end to keep the parts connected;
the pin is urged into engagement with a peg by a spring force;
the joint includes a toggle mechanism and the pin is caused to slide in use by means of the toggle mechanism;
the joint includes an actuation plate having a cam profile, the plate being adapted for causing the toggle mechanism to move during relative displacement of the plate and the toggle mechanism thereby to disconnect the two parts.
